(19) United States
(12) Patent Application Publication
(10) Pub. No.: US 2016/0258527 A1
(43) Pub. Date: Sep. 8, 2016

(54) SINTERED POWDER METAL PART HAVING RADIALLY-EXTENDING SPACED OPENINGS AND METHOD OF MAKING THEREOF

(71) Applicants: Alan C. TAYLOR, Lake Orion, MI (US); Jeffrey W. LEMKE, St. Thomas (CA)

(72) Inventors: ALAN C. TAYLOR, Lake Orion, MI (US); Jeffrey W. LEMKE, St. Thomas (CA)

(21) Appl. No.: 15/029,049

(22) PCT Filed: Sep. 11, 2014
(86) PCT No.: PCT/US2014/055077

§ 371 Date: Apr. 13, 2016

Related U.S. Application Data
(60) Provisional application No. 61/891,998, filed on Oct. 17, 2013.

(51) Int. Cl. F16H 57/04; B22F 3/24; B22F 5/08; B22F 3/16

(52) U.S. Cl. CPC F16H 57/0427; B22F 3/16; B22F 3/24; B22F 5/08; F16H 57/043; B22F 2003/245; B22F 2998/10; F16D 13/74

(57) ABSTRACT

A sintered powder metal part and a related method of making the part are disclosed. The sintered powder metal part, which is formed from a compacted and sintered powder metal, includes a hub having a radially-outwardly facing surface and a radially-inward facing surface. A toothed profile is formed in one of the radially-outwardly and radially-inward facing surfaces of the hub. One or more grooves are machined into the other of the surfaces of the hub such that the toothed profile and the one or more grooves are on oppositely-facing radial sides of the hub. The groove or grooves intersect with at least some of the tooth roots of the toothed profile to form a plurality of radially-extending spaced openings through the hub.

### CROSS-REFERENCE TO RELATED APPLICATION

This application claims the benefit of the filing date of U.S. Provisional Patent Application No. 61/891,998 filed Oct. 17, 2013, which is hereby incorporated by reference for all purposes.

### BACKGROUND

This disclosure relates to sintered powder metal parts and methods of making such parts. More specifically, this disclosure relates to ways of forming radially-extending spaced openings through a hub of a powder metal part so as to, for example, accommodate transport of oil or other lubricant from one radial side of the hub to the other.

In certain components, it is necessary to have oil or lubrication holes through the component to permit the flow of oil or lubricant from one place in the assembly to another place in the assembly. For example, in a clutch hub, oil is to be supplied from one side of the clutch hub to a clutch pack. In order to do this, a hub of the clutch hubs is conventionally drilled or pierced to produce a pathway through the clutch hub to permit the transport of the oil or lubricant therethrough. Additionally, on a radially-inward facing side of the hub, a cylindrical or tubular volume is typically machined out of the hub to provide a lubrication reservoir. On the axial end of the hub, a radially-inward facing annular lip or weir remains to define an end wall of the reservoir.

However, this process of (1) drilling or piercing the hub to form lubrication holes followed by (2) machining a tubular lubrication reservoir can be both expensive and time-consuming. Hence, a need exists for improved ways of forming openings and lubrication reservoirs in components having hubs.

### SUMMARY OF THE INVENTION

An improved way of forming radial through holes and lubricant reservoirs is disclosed herein using powder metallurgy and only minimal machining. In short, the powder metal is compacted into a form having a toothed profile in which at least some or all of the tooth roots are particularly deep on one face of the hub. On the other face of the hub, one or more grooves are machined that intersect at least some of these tooth roots. At these points of intersection, the tooth roots and the groove or grooves from a plurality of radially-extending spaced openings that can be used to permit transport of lubricant from one side of the hub to the other. Moreover, the groove or grooves can serve as a lubricant reservoir, meaning that a greater area of the hub does not need to be removed to provide a reservoir.

According to one aspect of the invention, a sintered powder metal part includes a hub having a radially-outwardly facing surface and a radially-inward facing surface. A toothed profile is formed in one of the radially-outwardly facing surface of the hub and the radially-inward facing surface of the hub. This toothed profile includes teeth and tooth roots. One or more grooves are machined into the other one of the radially-outwardly facing surface of the hub and the radially-inward facing surface of the hub (such that the toothed profile and the one or more grooves are on oppositely-facing radial sides of the hub). The groove(s) intersect with at least some of the tooth roots to form a plurality of radially-extending spaced openings through the hub.

In one form, this sintered powder metal part may be a clutch hub. However, it is contemplated that this part could be parts other than a clutch hub.

In some forms, the toothed profile may be formed in the radially-outward facing surface and the groove(s) may be machined into the radially-inward facing surface. In other forms, the toothed profile may be formed in the radially-inward facing surface and the groove(s) may be machined into the radially-outward facing surface.

It is contemplated that in some forms of the invention, the plurality of radially-extending spaced openings may be spaced apart from one another both circumferentially and axially.

The particular locations at which the openings are formed may be established by controlling the depth of the tooth roots. For example, at least some of the tooth roots may be deeper than others of the tooth roots. Then, depending on the depth of the machined groove, the groove may intersect the deeper tooth roots to form openings, but not intersect the shallower tooth roots.

The groove or grooves may take a number of different forms. For example, a groove may circumferentially extend around the hub (for example, the groove may be a circular recess on a plane perpendicular to the central axis of the hub). In another form, multiple grooves may be machined into the hub at an angle oblique to a central axis of the hub to form a screw thread pattern. In yet another form, the groove(s) may include a continuous groove that oscillates in an axial direction about the circumference of the hub (for example, in the pattern of a sine wave wrapped around the cylindrical surface). In still another form, the groove(s) may include a segment that only partially extends around the circumference of the hub.

It is contemplated that, in some forms, a depth of the tooth roots at their deepest may exceed a height of the teeth in the toothed profile. This is to say, the teeth have a standard height and that the additional amount of tooth root that is added to accommodate formation of the openings results in a greater depth than that for the teeth to properly engage another set of teeth. For example, there may be an intermediate shoulder at a root depth appropriate for engagement with a corresponding set of teeth and then there may be a subsequent deeper section of the tooth root which is provided primarily for the purpose of intersection with the groove.

In some forms, the tooth roots may have a rounded profile in cross section.

According to another aspect of the invention, a method of forming a plurality of radially-extending spaced openings through a hub of a sintered powder metal part is disclosed. A powder metal is compacted into a green preform which, upon sintering, becomes the sintered powder metal part. This green preform has a toothed profile formed in one of a radially-outwardly facing surface of the hub and a radially-inward facing surface of the hub. At least one groove is machined into the other of the radially-outwardly facing surface of the hub and the radially-inward facing surface of the hub such that the toothed profile and the groove are on oppositely-facing radial sides of the hub. The groove intersects with at least some of the tooth roots to form a plurality of radially-extending spaced openings through the hub.

According to some forms of the method, the method may further include the step of sintering the green preform to form the sintered powder metal part. The groove may be machined into the green preform either prior to sintering the green preform to form the sintered powder metal part or into the sintered powder metal part after sintering the green preform to form the sintered powder metal part.

According to the method, the toothed profile may be formed in the radially-outward or radially-inward facing surface during the compaction step and the groove(s) may be machined into the other of the surfaces during the machining step.

Again, as mentioned above, the groove may take a number of different forms (for example, be a circumferential groove, be machined at an angle oblique to the central axis of the hub, be a continuous oscillating groove, and/or include a segment that only partially extends around the circumference of the hub).

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a perspective view of a sintered powder metal part showing the toothed profile (in this instance, splines) on a radially-outward facing surface of a hub. The powder metal part is shown in section and only half of the sintered powder metal part is illustrated.

FIG. 2 is a perspective view of the sintered powder metal part of FIG. 1, shown from the reverse side to show the cross-sectional plane, in order to show the radially-inward facing surface of the hub and the groove machined therein.

FIG. 3 is a side view of an alternative sintered powder metal part showing the radially-outward facing surface of the hub in which three radially-extending spaced openings are illustrated as being formed in the hub.

FIG. 4 is a cross-sectional side view of the sintered powder metal part of FIG. 3 in which radially-inward facing surface of hub and the groove machined therein can be seen.

FIGS. 5 and 6 are a detailed perspective cross-sectional views of the sintered powder metal part of FIGS. 3 and 4, in which the cross section is taken through the intersection of one of the tooth roots and the groove that form the radially-extending opening through the hub.

FIG. 7 is yet another alternative sintered powder metal part similar to that illustrated in FIGS. 1 and 2, but in which the intersections of the tooth roots and the groove are regularly spaced such that the plurality of radially-extending openings are also regularly spaced. Only a cross-sectioned segment of the part is illustrated in FIG. 7.

FIG. 8 is a side view of the part of FIG. 7 in which the radially-outward facing surface of the hub is illustrated.

FIG. 9 is still another alternative sintered powder metal part similar to that illustrated in FIGS. 1 and 2, but in which the groove is formed circumferentially on a plane substantially perpendicular to the central axis of the hub.

FIG. 10 is another alternative sintered powder metal part similar to that illustrated in FIGS. 1 and 2, but in which a single chord or segment of groove is shown as being formed in the radially-inward facing surface of the hub.

FIG. 11 is an opposite side perspective view of the part of FIG. 10 in which the openings formed by the groove segment are illustrated on the radially-outward facing surface of the hub.

### DETAILED DESCRIPTION OF THE PREFERRED EMBODIMENT

In the detailed description that follows, like numbers will be used to designate like elements across the various illustrated embodiments, except for the differences that are noted and illustrated. This is true whether or not the specific feature numbered on the figure is explicitly described in each embodiment. As an example, feature 102 and its description in the first embodiment generally corresponds to feature 202 in the second embodiment, feature 302 in the third embodiment, and so forth.

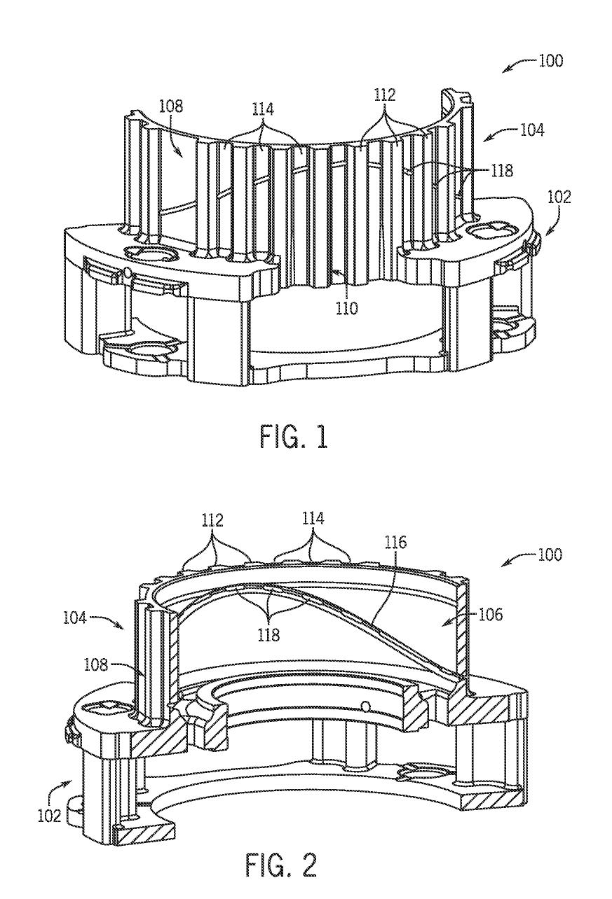

Referring first to FIGS. 1 and 2, a sintered powder metal part 100 in the form of a clutch hub is illustrated according to one aspect of this invention. The sintered powder metal part 100 includes a base 102 with a hub 104 extending axially upward therefrom. The hub 104 is generally tubular in shape and extends from one axial end which is connected to the base 102 to another axial end at the end of the hub 104. The hub 104 has a radially-inward facing surface 106 and a radially-outward facing surface 108.

On the radially-outward facing surface 108 of the hub 104, a toothed profile 110 is formed. The toothed profile 110 includes a plurality of teeth 112 extending axially along the hub 104 and spaced apart about the circumference of the hub 104. Between these teeth 112 are a plurality of tooth roots 114. At least some of these tooth roots 114 may be deeper than others. In this context, “deeper” means that the one tooth root is closer to the central axis of the hub than another tooth root in the orientation illustrated, although it is also contemplated that all of the tooth roots 114 could be at the same depth. Further, as it is used herein, the term “toothed profile” may refer to teeth, splines, or other tooth-like forms and should not be limited to only the illustrated toothed profiles.

As best seen in FIG. 2, on the radially-inward facing surface 106 of the hub 104, a groove 116 is machined. In this illustrated embodiment, this groove 116 is continuous and oscillates in an axial direction as the groove 116 extends circumferentially about the radially-inward facing surface 106. Accordingly, the groove 116 has a pattern resembling a sine wave. However, as will be illustrated in some of the other embodiments, the groove 116 may take on different shapes (for example, not axially oscillate, only be a segment, and so forth). Further, it will be appreciated that although only a single continuous groove is illustrated in FIGS. 1 and 2, that one or more grooves may be formed instead of just one.

It should be noted that although the toothed profile 110 is formed on the radially-outward facing surface 108 of the hub 104 and the groove 116 is formed on the radially-inward facing surface 106 of the hub 104, that the placement of these features could be reversed. That is to say, the toothed profile 110 could be formed on the radially-inward facing surface 106 while the groove 116 or grooves are formed on the radially-outward facing surface 108 of the hub 104. In the reverse arrangement from the illustrated embodiment, the depth of the tooth roots would be obviously reversed from the way that depth was defined above. Where the toothed profile 110 is formed on the radially-inward facing surface 106 of the hub 104, the deeper the tooth root 114 is, the further from the central axis of the hub 104 the tooth root 114 would be.

At the points of intersection between at least some of the tooth roots 114 and the groove 116, radially-extending openings 118 are formed. The formation of the radially-extending openings 118 occurs where the depth of the groove 116 on one side of the hub 104 intersects the depth of the tooth root 114 on the other side of the hub 104 such that there is an absence of material between the two, thereby creating the radially-extending openings 118. Thus, it can also be generally appreciated that, regardless of the configuration of the hub 104, the toothed profile 110 (with its tooth roots 114) should be on an opposite side of the hub 104 than the groove 116. Because the tooth roots 114 are spaced apart from one another about the circumference of the hub 104, this also means that the radially-extending openings 118 will be spaced about the circumference of the hub 104. Further, as the illustrated groove 116 oscillates in an axial direction as it travels around the circumference of the hub 104, the radially-extending openings 118 are also spaced axially from one other based on the points of intersection between the tooth roots 114 and the groove 116 or grooves.

It should be noted that, as illustrated in FIGS. 1 and 2, the radially-extending openings 118 are curved slots of differing length because of the geometries selected for the tooth roots 114 and the groove 116. However, as will be illustrated in other embodiments, the shape and form of the radially-extending openings 118 may be controlled through the selection of the geometries of the toothed profile 110 and the groove 116. Most, if not all, of the openings 118 extend for the entire width of the tooth root 114 so each spans the tooth root 114 through which it extends.

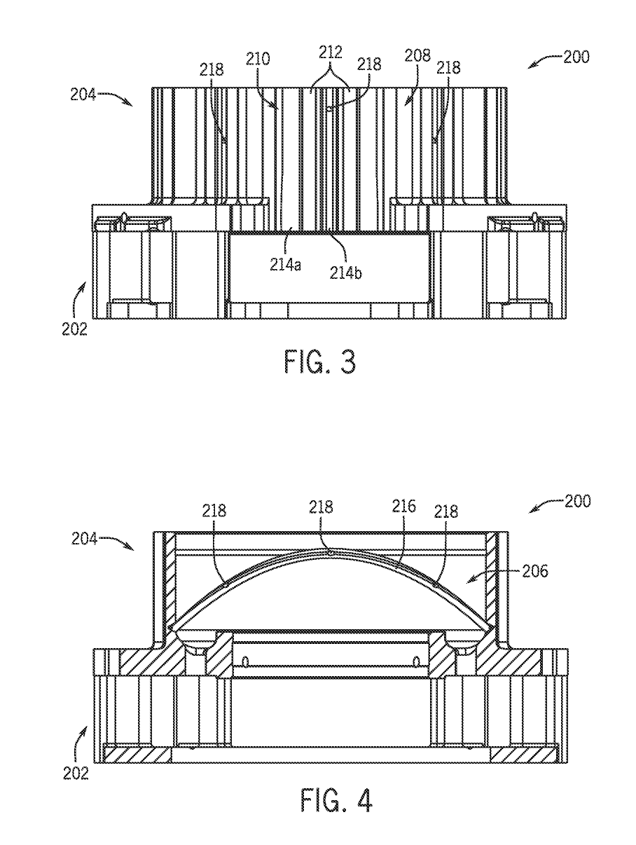

Referring now to FIGS. 3 and 4, a second embodiment of a sintered powder metal part 200 is illustrated in which the geometry of the toothed profile 210 has been modified to alter the number and shape of radially-extending openings 218. In this embodiment, only some of the tooth roots 214b in the toothed profile 210 on the radially-outward facing surface 208 of the hub 204 are deep enough to intersect with the groove 216 on the radially-inward facing surface 206 of the hub 204. As shown in the half of the part 200 illustrated in FIGS. 3 and 4, only three radially-extending openings 218 are formed through the side wall of the hub 204.

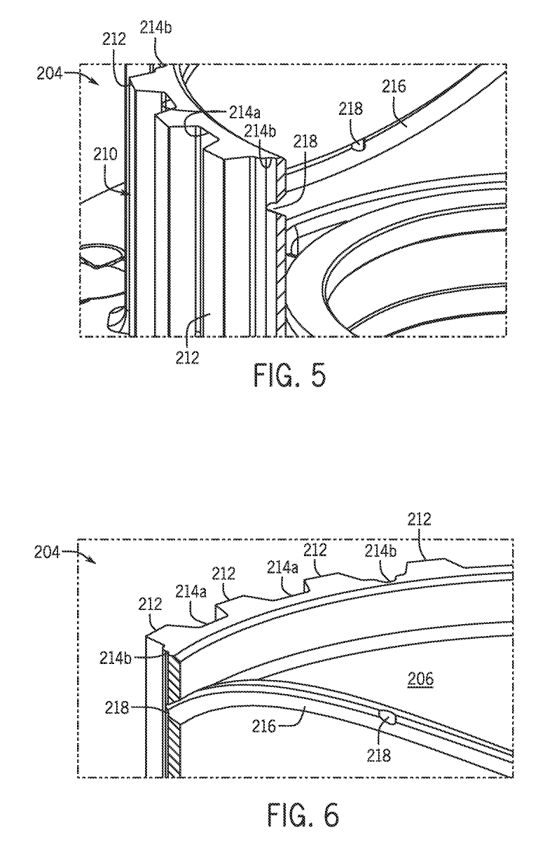

With additional reference to FIGS. 5 and 6, the variance in the depth of the tooth roots 214a and 214b in the second illustrated embodiment from FIGS. 3 and 4 can be seen in greater detail. As can be seen in FIGS. 5 and 6, some of the tooth roots 214a are shallow, whereas others of the tooth roots 214b are comparably deeper. FIGS. 5 and 6 include a cross section taken through one of the deeper tooth roots 214b as well as the space at the intersection between the groove 216 and the tooth roots 214b that form the radially-extending openings 218. Because, in the form illustrated, the groove 216 is formed to have a uniform depth relative to the radially-inward facing surface 206 of the hub 204, the groove 216 only intersects with the deeper tooth roots 214b to form radially-extending openings 218, and not the shallower tooth roots 214a.

Notably in the second embodiment shown in FIGS. 3-6, due to fewer tooth roots 214b of a sufficient depth to intersect with the corresponding groove 216, this second embodiment has fewer radially extending openings 218 that are spaced further apart from one another than in the embodiment of the part shown in FIGS. 1 and 2.

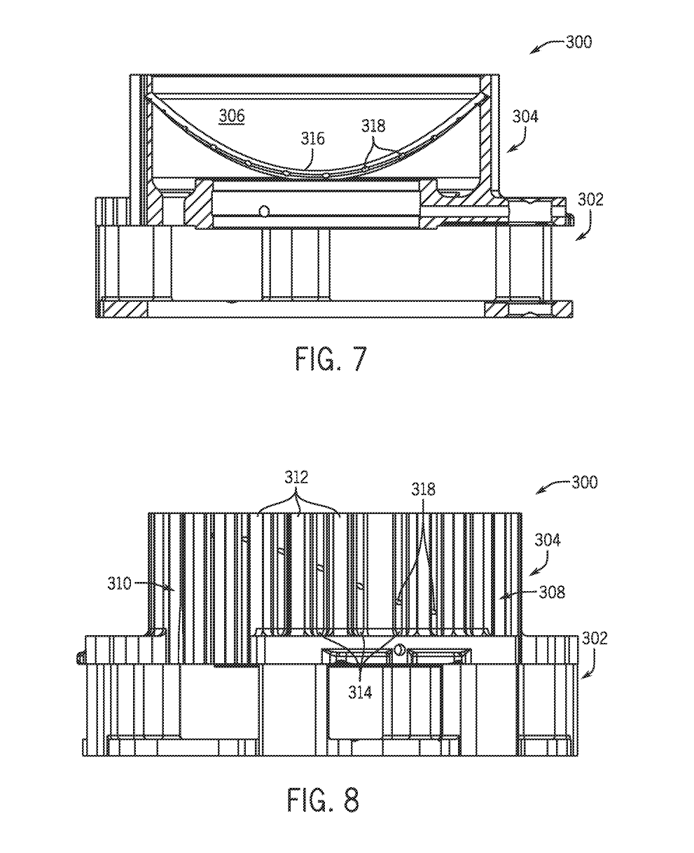

Turning now to FIGS. 7 and 8, a third embodiment is illustrated. In this sintered powder metal part 300, the toothed profile 310 on the radially-outwardly facing surface 308 of the hub 304 is regular, having teeth 312 and tooth roots 314 that occur in a regular pattern. Accordingly, when a groove 316 is formed or machined into the radially-inward facing surface 306, the circumferential spacing of the radially-extending openings 318 is more regular and only oscillates in the axial direction (as the groove 316 is made to oscillate axially as it circumferentially extends along around the hub 304).

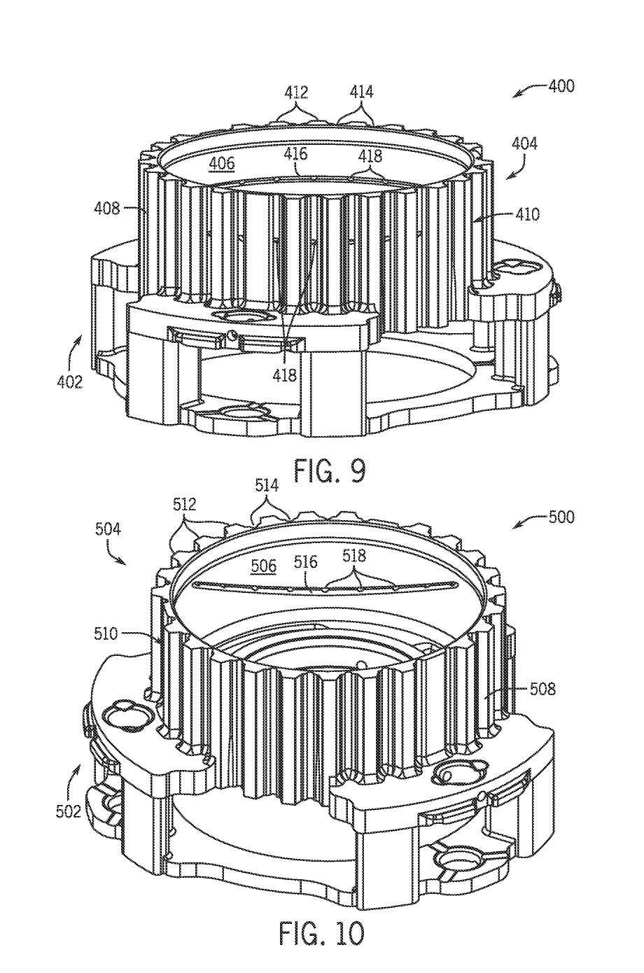

Yet another variation on the sintered powder metal part is illustrated in FIG. 9. In this sintered powder metal part 400, the groove 416 is formed as a simple annular ring in the radially-inward facing surface 406 of the hub 404 and has a circumference in a plane perpendicular to the central axis of the hub 404. Because the toothed profile 410 is regular, the intersection of the groove 416 and the tooth roots 414 in the toothed profile 410 results in radially-extending openings 418 spaced apart along a circumferential line around the hub 404 each at a similar axial height or position.

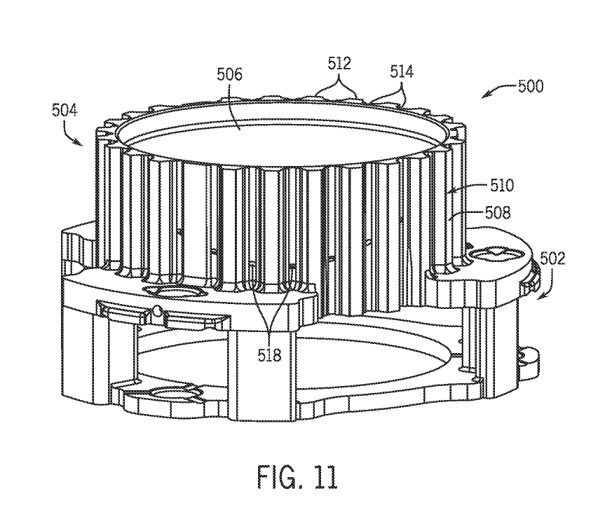

Finally, FIGS. 10 and 11 illustrate another embodiment in which the groove 516 is merely a single arced segment extending along a portion of the radially-inward facing surface 506 of the hub 504. Again, this results in the formation of radially-extending openings 518 at the intersection of the tooth roots 514 and the groove 516. This time, however, the openings are spaced along the segment of the groove 516.

As noted above in the background section, when placed into the greater assembly, these radially-extending openings can facilitate the transformation of lubricant from one side of the hub to the other. Moreover, by creating a groove in the hub, the groove can serve as a lubricant reservoir (as opposed to a larger machined area as found in some existing assemblies).

Further, although it is not illustrated in the figures, it is contemplated that one or more flutes may be pressed, machined, or otherwise formed into the toothed profile in order to fluidly link the channels defined in the space between the teeth and the tooth roots. Such flutes could extend in a generally circumferential direction to place the various channels of the tooth roots in fluid communication with one another to better distribute the lubricant. For example, it is contemplated that in some forms, a radially-extending opening might be formed in only some of the tooth roots to facilitate transport of lubricant through the wall of the hub while the flutes could facilitate transfer of the lubricant across the various channels in the toothed profile between the channels having an opening and those not having an opening.

Although a clutch hub is illustrated in the above-described embodiments, it is contemplated that other powder metal parts could be made to incorporate the invention other than a clutch hub.

The method of forming a powder metal part of the type described herein is now detailed.

First, a powder metal is compressed into a green preform. This compaction step is typically performed by filling a tool and die set with a powder metal and some amount of lubricant and/or binder. The lubricant and/or binder hold the powder metal particles together upon compaction and facilitate the ejection of the compacted preform from the tool and die set. The powder metal particles and lubricant and/or binder are compressed together under pressure (usually uniaxial pressure provided by two or more opposing punch tools) to form the green preform. During the compaction step, many of the fine or detailed features may be formed such as the toothed profile. Immediately after compaction, the groove is not present in the preform.

Eventually, the preform is sintered for a sintering time and at a sintering temperature (which is typically approaching, but below, the melting temperature of the powder metal) to cause the powder metal particles to diffuse and neck into one another, thereby forming a solid sintered powder metal part and causing a slight dimensional shrinkage of the part as the part increases in density. Because the process conditions can vary based on material of the powder metal and are often readily available from the powder supplier or scientific texts, specific time and temperature values are not explicitly provided in this application.

Either before sintering (when the part is still in a green state as a green preform) or after sintering (when the part is sintered together), at least one groove is machined into the other one of the radially-outwardly facing surface of the hub and the radially-inward facing surface of the hub, such that the toothed profile and the groove are on oppositely-facing radial sides of the hub. During this machining step, the groove or grooves intersects with at least some of the tooth roots in the toothed profile to form a plurality of radially-extending spaced openings through the hub. This machining step could be performed in a number of ways, but it is contemplated that it would most likely be performed with a lathe.

Again, the sintered powder metal parts may be made to having any of the forms illustrated above or to take on additional geometric variations to arrive at alternative positioning for the placement of the radially-extending openings.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A sintered powder metal part comprising:
a hub having a radially-outwardly facing surface and a radially-inward facing surface;
a toothed profile formed in one of the radially-outwardly facing surface of the hub and the radially-inward facing surface of the hub, the toothed profile including tooth roots;
at least one groove machined into the other of the radially-outwardly facing surface of the hub and the radially-inward facing surface of the hub such that the toothed profile and the at least one groove are on oppositely-facing radial sides of the hub;
wherein the at least one groove intersects with at least some of the tooth roots to form a plurality of radially-extending spaced openings through the hub.

2. The sintered powder metal part of claim 1, wherein the sintered powder metal part is a clutch hub.

3. The sintered powder metal part of claim 1, wherein the toothed profile is formed in the radially-outward facing surface and the at least one groove is machined into the radially-inward facing surface.

4. The sintered powder metal part of claim 1, wherein the toothed profile is formed in the radially-inward facing surface and the at least one groove is machined into the radially-outward facing surface.

5. The sintered powder metal part of claim 1, wherein the plurality of radially-extending spaced openings are spaced apart from one another circumferentially and axially.

6. The sintered powder metal part of claim 1, wherein at least some of the tooth roots are deeper than others of the tooth roots.

7. The sintered powder metal part of claim 1, wherein the at least one groove includes a groove circumferentially extending around the hub.

8. The sintered powder metal part of claim 1, wherein the at least one groove includes multiple grooves machined into the hub at an angle oblique to a central axis of the hub to form a screw thread pattern.

9. The sintered powder metal part of claim 1, wherein the at least one groove includes a continuous groove that oscillates in an axial direction about the circumference of the hub.

10. The sintered powder metal part of claim 1, wherein the at least one groove includes a segment that only partially extends around the circumference of the hub.

11. The sintered powder metal part of claim 1, wherein a depth of the tooth roots at their deepest exceeds a height of the teeth.

12. The sintered powder metal part of claim 1, wherein the tooth roots have a rounded profile in cross section.

13. A method of forming a plurality of radially-extending spaced openings through a hub of a sintered powder metal part, the method comprising:
compacting a powder metal into a green preform which upon sintering becomes the sintered powder metal part, the green preform having a toothed profile formed in one of a radially-outwardly facing surface of the hub and a radially-inward facing surface of the hub;
machining at least one groove into the other of the radially-outwardly facing surface of the hub and the radially-inward facing surface of the hub such that the toothed profile and the groove are on oppositely-facing radial sides of the hub;
wherein the groove intersects with at least some of the tooth roots to form a plurality of radially-extending spaced openings through the hub.

14. The method of claim 13, further comprising the step of sintering the green preform to form the sintered powder metal part.

15. The method of claim 14, wherein the groove is machined into the green preform prior to sintering the green preform to form the sintered powder metal part.

16. The method of claim 14, wherein the groove is machined into the sintered powder metal part after sintering the green preform to form the sintered powder metal part.

17. The method of claim 13, wherein the toothed profile is formed in the radially-outward facing surface during the compaction step and the at least one groove is machined into the radially-inward facing surface during the machining step.

18. The method of claim 13, wherein the toothed profile is formed in the radially-inward facing surface during the compaction step and the at least one groove is machined into the radially-outward facing surface during the machining step.

19. The method of claim 13, wherein the at least one groove machined into the hub includes a groove circumferentially extending around the hub.

20. The method of claim 13, wherein the at least one groove machined into the hub includes multiple grooves machined into the hub at an angle oblique to a central axis of the hub to form a screw thread pattern.

21. The method of claim 13, wherein the at least one groove machined into the hub includes a continuous groove that oscillates in an axial direction about the circumference of the hub.

22. The method of claim 13, wherein the at least one groove machined into the hub includes a segment that only partially extends around the circumference of the hub.
